(19) United States
(12) Patent Application Publication
(10) Pub. No.: US 2018/0262968 A1
(43) Pub. Date: Sep. 13, 2018

(54) METHOD AND APPARATUS FOR DETERMINING A ROUTING DESTINATION

(71) Applicant: Provenance Asset Group LLC, Essex, CT (US)

(72) Inventors: Joni JANTUNEN, Helsinki (FI); Veli-Matti KOLMONEN, Espoo (FI); Oskari KOSKIMIES, Helsinki (FI); Ilari TEIKARI, Helsinki (FI)

(21) Appl. No.: 15/756,503

(22) PCT Filed: Aug. 31, 2015
(86) PCT No.: PCT/FI2015/050560

§ 371 Date: Feb. 28, 2018

(51) Int. Cl. H04W 40/20; H04W 64/00; H04W 4/029; H04W 4/02

(52) U.S. Cl. CPC H04W 40/20; H04W 4/027; H04W 4/029; H04W 64/003

(57) ABSTRACT

This specification describes a method comprising: based on at least one of data included in a radio frequency data packet received from a trackable device (S2.1) and stored routing information associated with the trackable device (S2.3), determining which of local area network server apparatus and cloud server apparatus is to determine a position of the trackable device based on data derived from receipt of the radio frequency data packet (S2.11); and in response to determining that the cloud server apparatus is to determine the location of the trackable device, causing the data derived from the receipt of the radio frequency data packet to be routed towards the cloud server apparatus (S2.6).

### FIELD

This specification relates to determining a routing destination and, more specifically, to determining a routing destination for data upon which a determination of a position of a trackable device can be based.

### BACKGROUND

There are many different types of indoor positioning systems for enabling the determination of the position of trackable wireless devices within an indoor space. Some of these are already implemented while others are still under development. Such systems include Nokia's High Accuracy Indoor Positioning (HAIP) system which is configured to track the position of trackable devices using locator devices which utilise phased antenna arrays to determine a bearing between the trackable device and the locator device based on radio frequency (RF) data packets received at the locator device. This system is highly accurate and can provide accuracy of better than 30 centimetres. There are other systems, which may be referred to as cost-optimised indoor positioning (COIP) systems, which provide less accurate positioning but use less computational resources (e.g. electricity, processing power and bandwidth). These systems may utilise the signal strength of incoming data packets to provide room-level accuracy or, if a sufficient number of COIP locator devices are provided within a particular space, may utilise the signal strength in addition to fingerprinting (radio-maps) to provide an accuracy of approximately 2 meters.

In positioning systems, as with many other types of computing systems, it is beneficial to optimise the balance between the use of computing resources and performance of the system.

### SUMMARY

In a first aspect, this specification describes a method comprising: based on at least one of data included in a radio frequency data packet received from a trackable device and stored routing information associated with the trackable device, determining which of local area network server apparatus and cloud server apparatus is to determine a position of the trackable device based on data derived from receipt of the radio frequency data packet; and in response to determining that the cloud server apparatus is to determine the location of the trackable device, causing the data derived from the receipt of the radio frequency data packet to be routed towards the cloud server apparatus.

The method may comprise, in response to determining that the local area network server apparatus is to determine the location of the trackable device, either: causing the data derived from the receipt of the radio frequency data packet to be routed towards the local area network server apparatus; or causing the position of the trackable device to be determined based on the data derived from the receipt of the radio frequency data packet.

The data included in the radio frequency data packet received from the trackable device may be derived from an output of a movement sensor located at the trackable device and may be indicative of a degree of movement of the trackable device. In such examples, the method may further comprise determining which of the local area network server apparatus and the cloud server apparatus is to determine the position of the transmission based on a determination as to whether the degree of movement of the trackable device satisfies a predefined condition. The method may further comprise: determining that the local area network server apparatus is to determine the position of the trackable device if the data derived from the output of the movement sensor indicates that the degree of movement is above a threshold value; and determining that the cloud server apparatus is to determine the position of the trackable device if the data derived from the movement sensor indicates a degree of movement which is below a threshold value. The predefined condition may be indicated by the stored routing information.

The data included in the radio frequency data packet received from the trackable device may, in some examples, include an indicator comprising one or more bits, the state of which indicate which of the local area network server apparatus and the cloud server apparatus is to determine the position of the trackable device.

In some examples, the stored routing information may indicate a current routing destination for the data derived from the receipt of the radio frequency data packet. In such examples, the method may comprise receiving control information from the cloud server apparatus or the local area network server apparatus and responding by updating the current routing destination. The current routing destination may have been set based on a previously-determined position of the trackable device relative to a geo-fence. The geo-fence may be dynamically defined based on a position of a second trackable device.

In a second aspect, this specification describes a method comprising: determining a current context of a trackable device based on data associated with a radio frequency data packet transmitted by the trackable device; and based on the determined current context of the trackable device, causing transmission of a routing control message for indicating to a recipient which of a local area network server apparatus and a cloud server apparatus is to be used to determine a position of the trackable device based on subsequent radio frequency data packets transmitted by the trackable device. The method may further comprise: receiving the data associated with the radio frequency data packet transmitted by the trackable device; based on the received data, determining a position of the trackable device; and determining the current context based on at least the determined position of the trackable device. The current context may comprise at least one of a current position of the trackable device, a current movement characteristic and a current heading of the trackable device. The data associated with the radio frequency data packet transmitted by the trackable device may include at least one of data derived from receipt of the radio frequency data packet at a locator device and sensor data derived from at least one sensor forming part of the trackable device.

In a third aspect, this specification describes a method comprising: determining a current context of a trackable device based on data that is locally available to the trackable device; based on the determined current context of the trackable device, providing in a radio frequency data packet, for transmission by the trackable device to a locator device, an indicator for indicating which one of a local area network server apparatus and a cloud server apparatus is to be used to determine a position of the trackable device based on data derived from receipt of the radio frequency data packet at the locator device. The data that is locally available to the trackable device may include data derived from at least one sensor forming part of the trackable device. The at least one sensor may comprise a sensor for detecting movement of the trackable device and the current context may relate to a characteristic of the movement of the device.

In a fourth aspect, this specification describes apparatus configured to perform a method according to any of the first to third aspects.

In a fifth aspect, this specification describes computer-readable instructions which when executed by computing apparatus cause the computing apparatus to perform a method according to any of the first to third aspects.

In a sixth aspect, this specification describes apparatus comprising: at least one processor; and at least one memory including computer program code, which when executed by the at least one processor, causes the apparatus: based on at least one of data included in a radio frequency data packet received from a trackable device and stored routing information associated with the trackable device, to determine which of local area network server apparatus and cloud server apparatus is to determine a position of the trackable device based on data derived from receipt of the radio frequency data packet; and in response to determining that the cloud server apparatus is to determine the location of the trackable device, to cause the data derived from the receipt of the radio frequency data packet to be routed towards the cloud server apparatus.

The computer program code, when executed by the at least one processor, may cause the apparatus, in response to determining that the local area network server apparatus is to determine the location of the trackable device, either: to cause the data derived from the receipt of the radio frequency data packet to be routed towards the local area network server apparatus; or to cause the position of the trackable device to be determined based on the data derived from the receipt of the radio frequency data packet.

The data included in the radio frequency data packet received from the trackable device may be derived from an output of a movement sensor located at the trackable device and may be indicative of a degree of movement of the trackable device. The computer program code, when executed by the at least one processor, may cause the apparatus to determine which of the local area network server apparatus and the cloud server apparatus is to determine the position of the transmission based on a determination as to whether the degree of movement of the trackable device satisfies a predefined condition. The computer program code, when executed by the at least one processor, may cause the apparatus: to determine that the local area network server apparatus is to determine the position of the trackable device if the data derived from the output of the movement sensor indicates that the degree of movement is above a threshold value; and to determine that the cloud server apparatus is to determine the position of the trackable device if the data derived from the movement sensor indicates a degree of movement which is below a threshold value. The predefined condition may be indicated by the stored routing information.

The data included in the radio frequency data packet received from the trackable device may include an indicator comprising one or more bits, the state of which indicate which of the local area network server apparatus and the cloud server apparatus is to determine the position of the trackable device.

The stored routing information may indicate a current routing destination for the data derived from the receipt of the radio frequency data packet. The computer program code, when executed by the at least one processor, may cause the apparatus to receive control information from the cloud server apparatus or the local area network server apparatus and to respond by updating the current routing destination. The current routing destination may have been set based on a previously-determined position of the trackable device relative to a geo-fence. The geo-fence may be dynamically defined based on a position of a second trackable device.

In a seventh aspect, this specification describes apparatus comprising: at least one processor; and at least one memory including computer program code, which when executed by the at least one processor, causes the apparatus: to determine a current context of a trackable device based on data associated with a radio frequency data packet transmitted by the trackable device; and based on the determined current context of the trackable device, to cause transmission of a routing control message for indicating to a recipient which of a local area network server apparatus and a cloud server apparatus is to be used to determine a position of the trackable device based on subsequent radio frequency data packets transmitted by the trackable device. The computer program code, when executed by the at least one processor, may cause the apparatus: to receive the data associated with the radio frequency data packet transmitted by the trackable device; based on the received data, to determine a position of the trackable device; and to determine the current context based on at least the determined position of the trackable device. The current context may comprise at least one of a current position of the trackable device, a current movement characteristic and a current heading of the trackable device. The data associated with the radio frequency data packet transmitted by the trackable device may include at least one of data derived from receipt of the radio frequency data packet at a locator device and sensor data derived from at least one sensor forming part of the trackable device.

In an eighth aspect, this specification describes apparatus comprising: at least one processor; and at least one memory including computer program code, which when executed by the at least one processor, causes the apparatus: to determine a current context of a trackable device based on data that is locally available to the trackable device; based on the determined current context of the trackable device, to provide in a radio frequency data packet, for transmission by the trackable device to a locator device, an indicator for indicating which one of a local area network server apparatus and a cloud server apparatus is to be used to determine a position of the trackable device based on data derived from receipt of the radio frequency data packet at the locator device. The data that is locally available to the trackable device may include data derived from at least one sensor forming part of the trackable device. The at least one sensor may comprise a sensor for detecting movement of the trackable device and the current context may relate to a characteristic of the movement of the device.

In a ninth aspect, this specification describes a computer-readable medium having computer-readable code stored thereon, the computer readable code, when executed by a least one processor, cause performance of at least: determining, based on at least one of data included in a radio frequency data packet received from a trackable device and stored routing information associated with the trackable device, which of local area network server apparatus and cloud server apparatus is to determine a position of the trackable device based on data derived from receipt of the radio frequency data packet; and in response to determining that the cloud server apparatus is to determine the location of the trackable device, causing the data derived from the receipt of the radio frequency data packet to be routed towards the cloud server apparatus. The computer-readable code stored on the medium of the ninth aspect may further cause performance of any of the operations described with reference to the first aspect.

In a tenth aspect, this specification describes a computer-readable medium having computer-readable code stored thereon, the computer readable code, when executed by a least one processor, cause performance of at least: determining a current context of a trackable device based on data associated with a radio frequency data packet transmitted by the trackable device; and based on the determined current context of the trackable device, causing transmission of a routing control message for indicating to a recipient which of a local area network server apparatus and a cloud server apparatus is to be used to determine a position of the trackable device based on subsequent radio frequency data packets transmitted by the trackable device. The computer-readable code stored on the medium of the tenth aspect may further cause performance of any of the operations described with reference to the second aspect.

In an eleventh aspect, this specification describes a computer-readable medium having computer-readable code stored thereon, the computer readable code, when executed by a least one processor, cause performance of at least: determining a current context of a trackable device based on data that is locally available to the trackable device; based on the determined current context of the trackable device, providing in a radio frequency data packet, for transmission by the trackable device to a locator device, an indicator for indicating which one of a local area network server apparatus and a cloud server apparatus is to be used to determine a position of the trackable device based on data derived from receipt of the radio frequency data packet at the locator device. The computer-readable code stored on the medium of the eleventh aspect may further cause performance of any of the operations described with reference to the third aspect.

In a twelfth aspect, this specification describes apparatus comprising: means for determining, based on at least one of data included in a radio frequency data packet received from a trackable device and stored routing information associated with the trackable device, which of local area network server apparatus and cloud server apparatus is to determine a position of the trackable device based on data derived from receipt of the radio frequency data packet; and means for causing, in response to determining that the cloud server apparatus is to determine the location of the trackable device, the data derived from the receipt of the radio frequency data packet to be routed towards the cloud server apparatus. The apparatus of the twelfth aspect may further comprise means for causing performance of any of the operations described with reference to the first aspect.

In a thirteenth aspect, this specification describes apparatus comprising: means for determining a current context of a trackable device based on data associated with a radio frequency data packet transmitted by the trackable device; and means for causing, based on the determined current context of the trackable device, transmission of a routing control message for indicating to a recipient which of a local area network server apparatus and a cloud server apparatus is to be used to determine a position of the trackable device based on subsequent radio frequency data packets transmitted by the trackable device. The apparatus of the thirteenth aspect may further comprise means for causing performance of any of the operations described with reference to the second aspect.

In a fourteenth aspect, this specification describes apparatus comprising: means for determining a current context of a trackable device based on data that is locally available to the trackable device; means for providing, based on the determined current context of the trackable device, in a radio frequency data packet, for transmission by the trackable device to a locator device, an indicator for indicating which one of a local area network server apparatus and a cloud server apparatus is to be used to determine a position of the trackable device based on data derived from receipt of the radio frequency data packet at the locator device. The apparatus of the fourteenth aspect may further comprise means for causing performance of any of the operations described with reference to the third aspect.

### BRIEF DESCRIPTION OF THE FIGURES

For a more complete understanding of the methods, apparatuses and computer-readable instructions described herein, reference is now made to the following descriptions taken in connection with the accompanying drawings in which:

FIG. 1 is a simplified schematic illustration of a positioning system including a routing determination apparatus according to example embodiments;

FIG. 2 is a flowchart illustrating examples of various operations which may be performed by the routing determination apparatus;

FIG. 3 is a flowchart illustrating examples of various operations which may be performed by the cloud or local area network (LAN) server apparatuses shown in FIG. 1; and

FIG. 4 is a flowchart illustrating various operations which may be performed by the trackable devices of FIG. 1.

### DETAILED DESCRIPTION

In the description and drawings, like reference numerals may refer to like elements throughout.

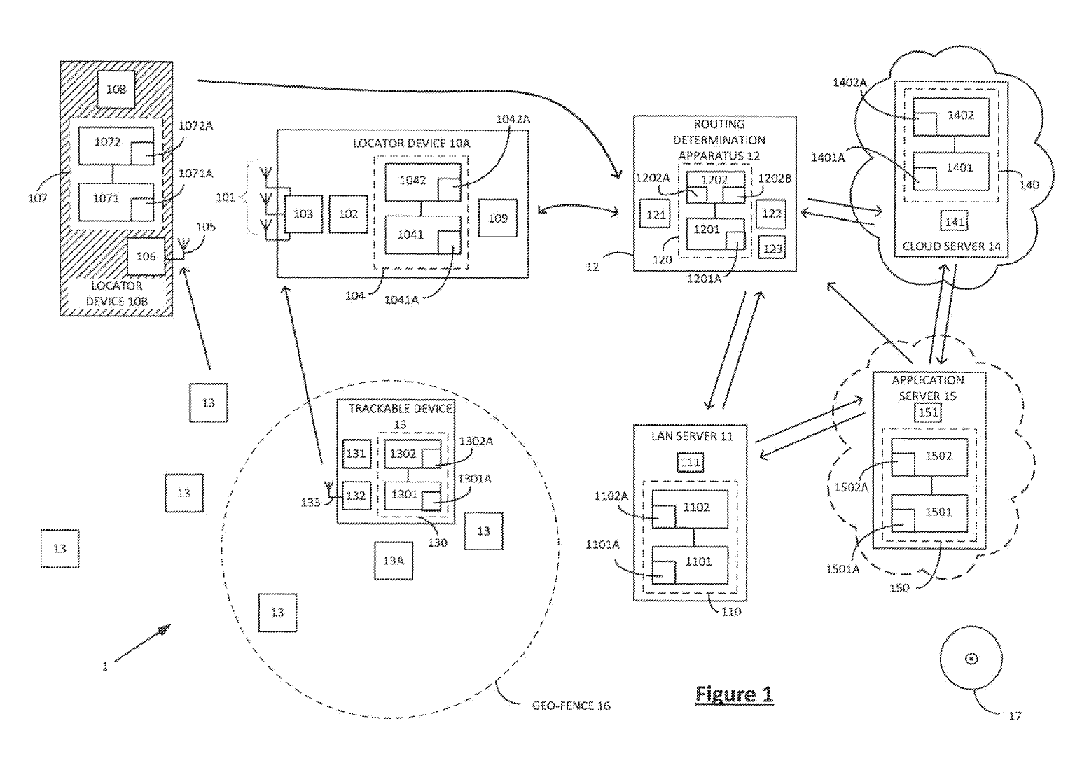

FIG. 1 is a simplified schematic of a positioning system 1 including routing determination apparatus 12 for optimising a balance between the use of computing resources of the local area positioning system and the performance, in terms of latency, of the system 1.

In the example of FIG. 1, the system 1 comprises local on-site infrastructure including one or more locator devices 10A, 10B, a server apparatus 11 and routing determination apparatus 12. Each of these components of the positioning infrastructure is located on premises and so may be referred to as part of the local area network (LAN). As such, the on-premises server apparatus 11 will hereafter be referred to as the LAN positioning server apparatus 11.

In addition to the LAN infrastructure elements, the system of FIG. 1 also comprises remote positioning server apparatus 14 which is located off-site and is accessible via, for instance, the internet. Such servers are commonly referred to as cloud servers and, as such, the off-site server apparatus will be hereafter referred to as the cloud positioning server apparatus 14. The cloud positioning server apparatus 14 may include one or more distinct servers to which data can be transmitted and from which data can be received via the internet. The LAN server apparatus 11 may comprise one or more distinct servers but these are located on-premises with data being provided to and received from the LAN positioning server apparatus via a wired or wireless local area network.

The positioning system 1 is configured such that the position of one or more trackable devices 13 can be determined based on radio frequency packets, such as Bluetooth low energy packets, transmitted from the trackable devices 13 to one or more of the locator devices 10A, 10B. Based on data derived from receipt of these radio frequency packets, both of the LAN positioning server apparatus 11 and the cloud positioning server apparatus 14 are operable to determine the position of the trackable devices 13.

The way in which the locations of the trackable devices 13 are determined may depend, on among other things, the configurations of the locator devices 10A, 10B and the format of the data packets transmitted by the trackable devices 13. In FIG. 1, two different types of locator devices are shown, although these are by way of example only as the configuration of the locator devices 10A, 10B may not be important. More specifically, in FIG. 1, the system is shown to include a locator device 10A which is of a first type which is based on high accuracy indoor positioning (HAIP) as developed by Nokia and another locator 10B which is of a second type and which utilises cost-optimised indoor positioning (COIP). These modes of positioning, and the respective locator devices, are discussed in more detail towards the end of the specification.

The routing determination apparatus 12 is configured to determine which of the LAN positioning server apparatus 11 and the cloud positioning server apparatus 14 should be used to determine the position of a particular trackable device 13 based on information derived from receipt of the radio frequency data packet by one of the locator devices 13. The determination as to which of the LAN positioning server apparatus 11 and the cloud positioning server apparatus 14 is used (which may be referred to as the routing determination) is based on at least one of data included in the radio frequency packet received from the trackable device 13 and stored routing information associated with the trackable device 13. The routing determination apparatus 12 is configured to respond to a determination that the cloud positioning server apparatus 14 is to determine the location of the trackable device 13 by causing the data derived from the receipt of the radio frequency data packet to be routed towards the cloud positioning server apparatus 14. The latency (i.e. the time taken) in determining and returning the position of a trackable device 13 is higher when the cloud positioning server apparatus 14 is used than when the LAN positioning apparatus 11 is used. However, use of the cloud positioning server apparatus 14 places less of a computational burden on the local area infrastructure of the positioning system.

The routing determination apparatus 12 comprises a controller 120 for making the above described determination and for providing the various other functionalities described herein. The routing determination apparatus 12 further includes an input interface 121 for receiving data from the locator devices 10A, 10B and first and second input/output (I/O) interfaces 122, 123 for providing data to and, if applicable, receiving data from the cloud positioning server apparatus 14 and the LAN positioning server apparatus 11 respectively. At least one of the I/O interfaces 122, 123 may additionally be configured to receive data from an application server apparatus 15. The input interface 121 and the I/O interfaces may be of any suitable type depending on the mode of communication between the various entities in the system 1.

The routing determination apparatus and the LAN positioning server apparatus may be separate entities. In such examples, the routing determination apparatus 12 is configured to respond to a determination that the LAN positioning server apparatus 11 is to determine the location of the trackable device by causing the data derived from the receipt of the RF data packet to be routed towards the LAN positioning server apparatus 11. In other examples, however, the routing determination apparatus 12 may form part of the local area network server apparatus 11. In those cases, the routing determination apparatus 12 may respond to the determination that the local area network server apparatus 11 is to be used to determine the location of the trackable device 13 by causing the LAN positioning server apparatus 11 to determine the position of the trackable device. When the routing determination apparatus 12 forms part of the LAN positioning server apparatus 11, the routing determination and the position determination may be carried out by separate controllers 120, 110 (as is the case in the system of FIG. 1) or may both be performed by a single controller, for instance the controller 110 of the LAN positioning server apparatus 12. In yet other examples, a routing determination apparatus 12 may form part of each locator device 10A, 10B.

The determination as to which of the cloud and LAN positioning server apparatuses 11, 14 should determine the position of the trackable device 13 may be based on data included in the radio frequency data packet which is derived from an output of at least one movement sensor 131 (e.g. an accelerometer) forming part of the trackable device 13 and which is indicative of a degree of movement of the trackable device. The determination by the routing determination apparatus 12 may be made on the basis of a determination as to whether a characteristic of the movement (e.g. velocity, acceleration, deceleration etc.) of the device 13 as indicated by the data included in the RF data packet satisfies a predefined condition. For instance, the routing determination apparatus 12 may be configured to determine that the LAN server apparatus 11 should determine the position of the trackable device 13 if the data derived from the output of the movement sensor 131 indicates that a particular movement characteristic is above a threshold value (e.g. the trackable device is moving with a speed or acceleration above a threshold value). Conversely, if the data derived from the movement sensor 131 indicates that the characteristic of movement of the trackable device is below a threshold value, the routing determination apparatus 12 may be configured to determine that the cloud server apparatus 14 should determine the position of the trackable device 13. In this way, when the device is moving quickly, the latency in determining the position is less and so a more accurate record of the location of the device 16 can be obtained. The predefined condition may be indicated by the stored routing information relating to the trackable device 13 which is stored by the routing determination apparatus 12.

In some examples, the routing determination apparatus 12 may be configured to determine which of the LAN and cloud positioning server apparatuses 11, 14 should be used to determine the position of the trackable device 13 based on an indicator or flag included in the radio frequency data packet. The indicator or flag may comprise one or more data bits, and the state of these bits indicate to the routing determination apparatus 12 which of the server apparatuses 11, 14 should be used to determine the position of the trackable device 13.

The indicator may be provided by the trackable device in dependence on a current context of the trackable device 13 which is determined based on data that is locally available to the trackable device 13. The data may include data output by at least one sensor 131 (which may, for instance, be a movement sensor such as an accelerometer, a temperature sensor, a vibration sensor, a light sensor or any other sensor), stored data identifying a type of the trackable device 13, a priority or importance associated with the trackable device 13 or its user, a time of day or data derived from a user input in respect of the trackable device. The current context may thus include one or more of many different factors including a characteristic of the movement of the device, the time, the type of the device etc. The indicator may be provided in the data packet in dependence on a comparison of the current context with one or more specific criterion each relating to a different factor which contributes towards the current context. For instance, where the current context relates to whether or not the device is moving, the device 13 may compare the current level of a particular movement characteristic with a threshold. In dependence on the outcome of the comparison, the device sets the indicator in the data packet accordingly. Consequently, the trackable device 13 may dictate to the routing determination apparatus whether the cloud server apparatus 14 or the LAN server apparatus 11 should be used to determine its position.

The routing determination apparatus 12 may be configured to store a routing database 1202B including stored routing information corresponding to each of a plurality of trackable devices 13 which are active within the positioning system 1. This stored routing information may indicate a current routing destination for the data derived from the receipt of radio frequency packets from a particular trackable device 13. Consequently, the routing determination apparatus 12 may respond to an indication that a radio frequency data packet has been received by using a trackable device ID which is extracted from the data packet to identify the current routing destination from the routing database. The current routing destination indicates to which of the LAN and cloud positioning server apparatuses 11, 14 the data derived from the receipt of the radio frequency data packet should be provided. The current routing destination may be predefined and may be determined based on a number of different criteria such as the previously determined position of the trackable device, a priority associated with the trackable device, a type of the trackable device, a previously observed level of movement (e.g. speed, acceleration or deceleration) of the trackable device or a time of day.

The routing determination apparatus 12 may be further configured to receive routing control messages from either or both of the cloud and LAN positioning server apparatuses 11, 14. In response to receiving a routing control message, the routing determination apparatus 12 may update the current routing destination in the routing database 1202B for a particular trackable device 13. In such examples, the server apparatuses 11, 14 may be configured to determine a current context of a trackable device based on data associated with a radio frequency data packet transmitted by the trackable device and, based on the current context may cause transmission of a routing control message for indicating to the routing determination apparatus which of the LAN server apparatus and the cloud server apparatus should be used to determine the position of the trackable device based on subsequent radio frequency data packets transmitted by the trackable device.

The current context of the trackable device may be determined based on at least one of data derived from receipt of the radio frequency data packet at a locator device 10A, 10B and sensor data 131 derived from at least one sensor 131 forming part of the trackable device. The current context of the device 13 may include its current position. In addition or alternatively, the current context may include a current movement characteristic and a current heading of the trackable device. The server apparatus 11, 14 may determine whether or not to cause transmission of a routing control message based on a comparison of current context with one or more criterion. For instance, if the current context includes location and speed of the device, the one or more criterion may include a predetermined area and a threshold speed. In such an example, the server apparatus 11, 14 may determine if the position of the device 13 is within the predetermined area and whether the speed exceeds the threshold. If both (or in some examples, just one) of the criterion are satisfied, the server apparatus 11, 14 may determine that it is not the most appropriate server to determine the position of the trackable device 13 and may respond by transmitting the routing control message to the routing determination apparatus 12. In other examples, the current context may include only the position of the trackable apparatus and the routing control message may be sent by the respective one of the server apparatuses 11, 14 when it is determined that a relationship between a position of the trackable device 13 and a geo-fence (a virtual border between two areas) has changed. For instance, the system 1 may be configured such that when a trackable device is within a particular area, the perimeter of which is indicated by a geofence, the position determination should be performed by the LAN positioning server apparatus 11 but when the trackable device 13 is outside the geo-fence the position determination should be performed by the cloud server apparatus 14.

As will be appreciated from the below discussion of the various uses of the positioning system 1 described in the specification, the geofence may in some examples be defined relative to the position of another trackable device 13. For instance, low latency position determination may be preferable for all trackable devices 13 within a particular radius of another trackable device of particular interest but high latency position determination may be acceptable for trackable devices that are outside the radius from the trackable device of interest. Such a geo-fence 16 is illustrated in FIG. 1 and is defined relative to a particular trackable device 13A. In some examples, it may be preferable that the positions of all trackable devices within the geo-fence 16 are determined with low latency by the LAN positioning server apparatus 11 with positions of devices outside the geo-fence being determined with high latency (by the cloud server apparatus).

As can be seen from FIG. 1, the positioning system may further include an application server apparatus 15 which is configured to receive information identifying the determined positions of the trackable devices 13 from the LAN and cloud server apparatuses 11, 14. This may be located either on-premises or in the cloud. The application server apparatus 15 may be configured to output data for enabling provision of a user interface including a visual display of the locations of the trackable devices 13 to a user. The user may be able to interact with this user interface to select particular trackable devices 13 thereby to dictate which of the cloud server apparatus 14 and the LAN server apparatus 11 should be used to determine the position for those trackable devices 13. For instance, the user may be able to interact with the user interface to define a geo-fence 16. In response to this, the application server 15 causes transmission of information indicative of the geo-fence to be transmitted to the LAN and cloud server apparatuses 11, 14. Similarly, the user may be able to select a single trackable device 13 from the user interface thereby to indicate that the latency for the positioning determination for that device should be changed. The user interface may be configured such that trackable devices 13 for which the LAN server apparatus 11 determines the position are indicated in a first colour and the trackable devices 13 for which the cloud server apparatus is currently used to determine the position are indicated in a second colour. The application server apparatus 15 may thus respond to a selection of a particular device (e.g. by touching, clicking or zooming in on the visual indication of the device) by sending a control signal to the routing determination apparatus 12 for updating the current routing destination for that device 13 in the routing database 1202B.

In some examples the user interface may allow the user to specify a combination of criteria. For instance, the user may specify a trackable device 13 of interest relative to which a first geo-fence is defined, e.g. a radius of 5 meters from the trackable device of interest, and may further define a second geo-fence which indicates a particular area within the indoor space. Information indicative of these geo-fences is then caused to be transmitted by the application server 15 to the positioning servers 11, 14 which use that information for determining when control information should be sent to the routing determination apparatus 12 to update the current routing destination in the routing database 1202B. Similarly, the user interface may be configured to enable the user to also or alternatively select a threshold of a movement characteristic based on which the routing determination apparatus 12 should make its determination. As such, the user may define, for instance, a threshold velocity which the application server apparatus 15 then indicates to at least one of the routing determination apparatus 12, the LAN server apparatus 11 and the cloud server apparatus 14 and based on which the routing determination is then made.

As can be seen from FIG. 1, each of the LAN positioning server apparatus 11, the cloud positioning server apparatus 14 and the application server apparatus 15 include a respective controller 110, 140, 150 (which are discussed in more detail towards the end of the specification) for providing the respective functionalities described herein. In addition, the server apparatuses 11, 14, 15 include respective I/O communication interfaces 111, 141, 151 via which data is transmitted and received (in any suitable way, using any suitable protocol) to/from the other elements in the system 1.

The trackable device 13 comprises at least a controller 130 and transceiver circuitry 132. The controller 130 (the configuration of which is discussed in more detail below) is configured to provide the functionality discussed herein and also to control the operation of transceiver circuitry 132 to transmit and receive data packets via an antenna 133. In some examples which will be discussed in more detail below, the trackable device 13 may also include one or more sensors 131 for detecting conditions associated with the trackable device 13. The trackable devices 13 may be electronic tags, more complex devices such as a personal computing/communications device (such as, but not limited to, a mobile phone, a tablet computer or a wearable computing device such as a smart watch) or any combination of any suitable type of trackable device.

The trackable devices 13 and the locator devices 10A, 10B may be configured to communicate using any suitable wireless transmission protocol. In some specific examples, however, the transceivers 132, 102, 106 of the trackable devices 13 and the locator devices 11 may each be configured, under the control of respective controllers, to communicate with each other via a Bluetooth transmission protocol. For instance, the transceivers 132, 102, 106 may be configured to transmit and/or receive data packets (including data packets for enabling position determination) using a Bluetooth Low Energy protocol, as described in or compatible with the current version of the Core Bluetooth specification (Version 4.2). In other examples, however, at least some of the devices 13 may also or additionally be configured to communicate using another suitable protocol. Such protocols may include but are not limited to 802.11 wireless local area network protocols, other types of Bluetooth protocol or IEEE 802.15.4 protocols.

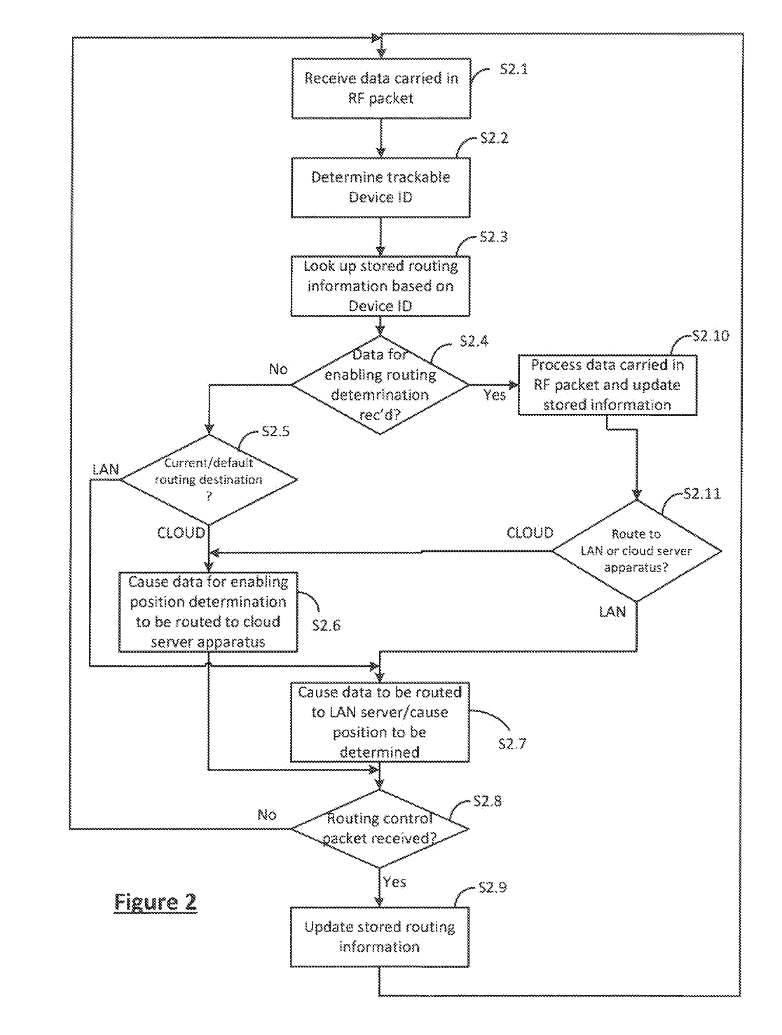

FIG. 2 is a flowchart illustrating various functionalities which may be provided by the routing determination apparatus 12 under the control of its controller 120.

In operation S2.1, the routing determination apparatus 12 receives data derived from receipt of an RF data packet at one of the location devices 10A, 10B. This data may include data carried in the RF data packet transmitted by one of the trackable devices 13. The data carried in the RF packet includes the device ID for identifying the trackable device 13 and may additionally include a flag for indicating to which of the cloud server 14 and the LAN server 11 the data for enabling the position of the trackable device 13 to be determined should be routed. Put another way, the flag may indicate whether low or high latency processing is required for the position determination. In some examples, the data carried in the RF packet may (in addition to or instead of the flag) include data derived from the one or more sensor 131 included in the trackable device 13. The sensor 131 may, for instance, be a movement sensor such as an accelerometer, a temperature sensor, a vibration sensor, a light sensor or any other sensor based on which a determination between high and low latency position determination might be made.

In addition to the data carried in the RF packet, the routing determination apparatus 12 in operation S2.1 also receives data derived from the receipt of the RF packet at the locator device 10A, 10B and based on which the position determination may be made. For instance, when HAIP is being used, the data derived from the receipt of the packet may include I and Q data, and in some cases also an indication of the signal strength of the received packet. When COIP is used, the data may include only the signal strength.

Next, in operation S2.2, the routing determination apparatus 12 determines the trackable device ID and in operation S2.3 uses the trackable device ID to look up the stored routing information associated with the trackable device 13 from the routing database 1202B. As discussed previously, the stored routing information may indicate a current routing destination for the trackable device 13. In other examples, the stored routing information may include other information (e.g. predefined conditions, threshold values etc) which may be used by the routing determination apparatus 12 in conjunction with received data to make the determination as to which server apparatus 11, 14 should be used to determine the position of the trackable device 13.

Following operation S2.3, there are a number of different ways in which the routing determination apparatus 12 might proceed. In a first example, the routing determination apparatus 12 may proceed to performance of operation S2.5. Such examples may be applicable, for instance when the routing determination apparatus 12 performs the routing determination based only on the stored routing information stored in the routing database 1202B. In such examples, the stored routing information may comprise information indicating a current routing destination for a particular trackable device 13. As such, the stored routing information may indicate either the cloud positioning server apparatus 14 or the LAN positioning server apparatus 11.

In operation S2.5, the routing determination apparatus 12 determines which of the cloud server apparatus 14 and the LAN server apparatus 11 is indicated by the stored routing information. If the stored routing information indicates the cloud server apparatus 14, operation S2.6 is performed in which the routing determination apparatus 12 causes the data for enabling the position determination to be routed to the cloud server apparatus 14. In addition, at least some of the contents of the received RF packet may also be routed to the cloud server apparatus 14. This may include the trackable device ID and in some instances the data derived from one or more sensors 131 located at the trackable device 13

Alternatively, if the stored routing information indicates that the current routing destination is the LAN server apparatus 11, the routing determination apparatus 12 causes the data for enabling the position determination and the trackable device ID (and optionally also data derived from sensors at the trackable device) to be routed to the LAN server apparatus 11. Alternatively, in examples in which the routing determination apparatus 12 is part of the LAN server apparatus 11, the routing determination apparatus 12 responds to a determination in operation S2.5 that the LAN server apparatus 11 should determine the position of the trackable device 13 by causing the position to be determined.

Although not illustrated on FIG. 2, the respective server apparatuses 11, 14 respond to receipt of the data derived from receipt of the RF data packet by determining the position of the subject trackable device 13. In addition, the server apparatuses 11, 14 may also determine a current context of the trackable device and compare this with one or more predetermined condition thereby to determine whether it is the most suitable server for determining the position of the trackable device 13 based on future RF packets. For instance, current context may include the current position of the device and the server apparatuses 11, 14 may compare the current position with a geo-fence and depending on the position of the device relative to the geofence may cause a routing control message to be transmitted to the routing determination apparatus 12 for updating the routing database 1202B. Similarly, the current context may include one or more movement characteristic and the server apparatuses 11, 14 may be configured to compare the movement characteristic (e.g. velocity) of the device 13 with predetermined condition (e.g. a threshold). If the movement characteristic satisfies the predetermined condition, the server apparatuses may respond by causing the routing control message to be transmitted to the routing determination apparatus 12 for updating the routing database 1202B. The velocity may be determined based on for instance successively determined positions of the trackable device, details of which may be stored by the server apparatus. Alternatively the movement characteristic may be determined using data derived from a movement sensor located in the trackable device which was transmitted in the RF packet and/or based upon successively determined positions of the trackable device 13.

Returning now to FIG. 2, after performing either of operations S2.6 and S2.7, the routing determination apparatus 12 proceeds to operation S2.8. In operation S2.8, it is determined whether a routing control message has been received from either of the server apparatuses 11, 14.

If it is determined that a routing control message has not been received, the routing determination apparatus 12 returns to operation S2.1. If, however, a routing control message has been received, the routing determination apparatus 12 proceeds to operation S2.9 in which the stored current routing destination is updated in the database 1202B. For instance, if a routing control message is received from the cloud server apparatus 14, the routing determination apparatus 12 may respond by updating the current routing destination for the trackable device 13 to which the control signal relates to specify that, for subsequently received data packets, the position should be determined by the LAN server apparatus 11. Conversely, if the routing control signal is received from the LAN server apparatus 11, the routing determination apparatus 12 may respond by updating the current routing destination for the trackable device 13 to specify that for subsequent RF packets the position should be determined by the cloud server apparatus 14. As discussed previously, routing control messages may also be received from the application server apparatus 15, for instance following a user selection of a particular trackable device.

After updating the stored routing information in operation S2.9, the routing determination apparatus 12 returns to operation S2.1.

In other examples, in which the routing determination apparatus 12 is operable to determine the routing destination based on the stored routing information and the data carried in the RF packet, the routing determination apparatus 12 may proceed from operation S2.3 to operation S2.4.

In operation S2.4, the routing determination apparatus 12 determines whether data, based on which a routing determination can be made, has been received. As discussed previously, such data may include a flag indicating the routing destination or data derived from one or more sensors 131 located at the trackable device 13. If no such data has been received, the routing determination apparatus 12 may proceed to operation S2.5 in which a routing destination is determined based on only the stored information. If there is no stored routing information relating to the subject trackable device 13, the routing determination apparatus 12 may determine a default routing destination. If, on the other hand, the received data does include data for enabling a routing determination, the routing determination apparatus 12 proceeds to operation S2.10.

In operation S2.10, the data for enabling the routing determination is processed and the stored information updated, as necessary. For instance, where the data is derived from an accelerometer but the routing determination is based on the velocity of the trackable device 13, the routing determination apparatus 12 may be configured to process the received accelerometer data in combination with previously-stored accelerometer data relating to the trackable device thereby to determine the velocity. In addition, the routing determination apparatus 12 may update the stored information with the newly received accelerometer data. It will of course be appreciated that different processing may be performed dependent on the condition on which the routing determination is based.

Subsequently, in operation S2.11, the routing determination apparatus 12 determines the routing destination based on the processed received data and optionally also the stored routing information. As will be understood from the previous description, in some examples the routing determination may be made solely on the basis of a flag that is present in the RF packet and indicates the routing destination. Alternatively, the determination of S2.11 may be made on the basis of sensor data and a predetermined condition which is defined by the stored information. The stored information in such examples may additionally include historic sensor data relating to the trackable device for enabling the determination to be made. For instance, in some examples the stored information may define a condition with respect to the velocity of the trackable device and the routing determination apparatus 12 may determine the routing destination based on whether or not the sensor data (optionally in combination with the stored sensor data) indicates that the predefined condition with respect to the velocity has been met. As will be appreciated, different predefined conditions may be stored in respect of different trackable devices.

In operation S2.11, the routing determination apparatus 12 makes a decision between the cloud server apparatus 14 and the LAN server apparatus 11 as the routing destination. If the cloud server apparatus 14 is determined as the routing destination, the routing determination apparatus 12 proceeds to operation S2.6. If, however, the LAN server apparatus 11 is determined as the routing destination, the routing determination apparatus 12 proceeds to performance of operation S2.7.

Although not shown in FIG. 2, in some examples the routing destination determination may be made solely on the basis of data carried in the RF packet and may not be based on stored routing information at all. In such examples, the method may proceed from either of operations S2.1 or S2.2 directly to operation S2.11 in which the routing destination determination is made solely on the basis of the received data carried in the RF packets. Such examples may apply when, for instance, the RF packet carries a flag which indicates the routing destination.

In some examples, the routing determination may be made on the basis of a current number of devices for which the LAN server apparatus 11 is the current routing destination (as indicated by the routing database). For instance, there may be a limit on the number of devices for which the LAN server apparatus may determine the position. After the limit is reached, data derived from data packets from other devices may be routed by the routing determination apparatus 12 to the cloud server apparatus 14. In other examples, the determination as to which devices have their positions determined by the LAN server apparatus 11 may be based on a comparison of the current contexts of the devices. For instance, only data relating to the twenty devices (or whatever the limit is) whose speed is the highest or who are closest to a particular location will be routed to the LAN server apparatus. Data relating to all other devices may be routed to the cloud server apparatus 14.

As will be appreciated, the methods and apparatuses described with reference to FIGS. 1 and 2 may provide optimisation of the balance between latency of the position determination and use of local computational resources.

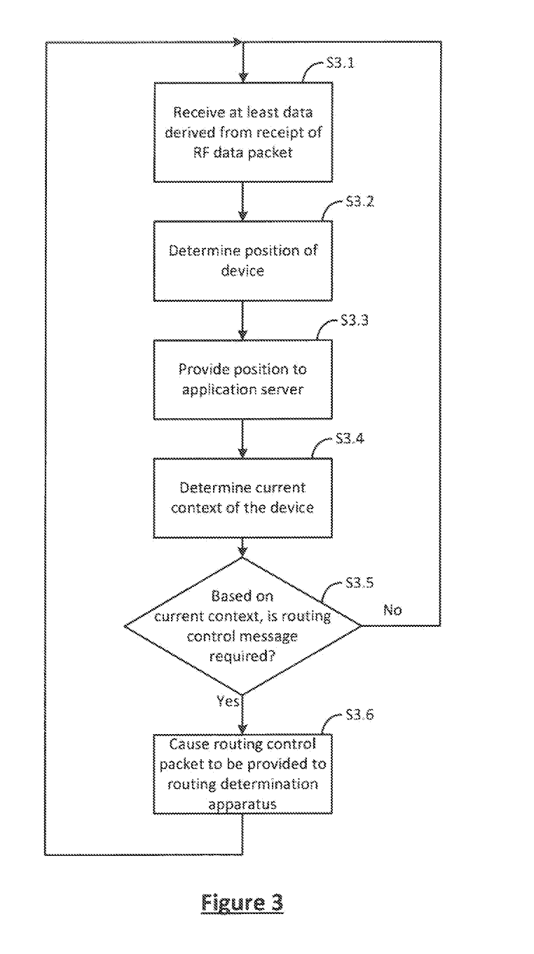

FIG. 3 is a flowchart showing an example of a method that may be performed at either of the cloud server apparatus 14 and the LAN server apparatus 11, under the control of respective controllers 140, 110 according to some examples.

In operation S3.1, the server apparatus 11, 14 receives the data derived from receipt of the RF packet at the locator device 10. In addition, the trackable device ID is received. In some examples, sensor data derived from one or more sensors 131 at the trackable device 13 may additionally be received.

Next, in operation S3.2, the server apparatus 11, 14 determines the position of the trackable device 13 based on the received data. For instance, in a HAIP, the received data may include I/Q data which may enable the angle of arrival of the data packet at the locator device to be determined. Based on the angle of arrival and the information identifying the location of the locator device and its orientation, the position of the trackable device 13 may be determined. In other examples, for instance, in which such high accuracy positioning is not required or in positioning system of a different type, the position of the trackable device may be determined, for instance based on signal strength information relating to the signal strength of the received RF packet.

Subsequently, in operation S3.3, the server apparatus 11, 14 causes the determined position of the trackable device to be transmitted to the application server 15 along with the device ID.

Next, in operation S3.4, the server apparatus 11, 14 determines the current context of the device, which may be based on any of the factors described previously. Next, in operation S3.5, the server apparatus 11, 14 determines, based on a comparison between the current context and one or more stored routing conditions for the trackable device, whether it is required to send a routing control message. As discussed previously, the stored routing conditions may relate to one or more geo-fences and/or one or more conditions relating to movement of the trackable device 13 (e.g. acceleration, velocity, deceleration etc.). When the routing condition relates to a geo-fence, the routing condition may, for instance, be satisfied if the determined position of the trackable device is no longer within the geo-fence or, alternatively, is no longer outside the geo-fence. With regards to conditions relating to movement of the trackable device 13, the condition may be satisfied if a characteristic associated with the movement of the device no longer has a particular relationship with respect to a threshold value or a range of values.

Following a determination in operation S3.5 that satisfied routing control message should be sent, the respective server apparatus 11, 14 proceeds to operation S3.6 in which a routing control message is caused to be provided to the routing determination apparatus 12. After this the server apparatus 11, 14 returns to operation S3.1. If on the other hand, it is determined that a routing control message is not required, the server apparatus returns to operation S3.1.

It will therefore be appreciated that, in some examples, the positioning server apparatuses 11, 14 may dictate the routing destination for data associated with further RF packets from a particular trackable device 13.

As will be appreciated, there may be some instances in which none of the trackable devices 13 in the system require low-latency tracking and as such, no data will be routed to the LAN server apparatus 11. In such situations, the LAN server apparatus 11 may be configured to put itself in to a sleep (or low energy) mode after a period of inactivity. The LAN server apparatus 11 may then wake itself up again following receipt of data from the routing determination apparatus 12.

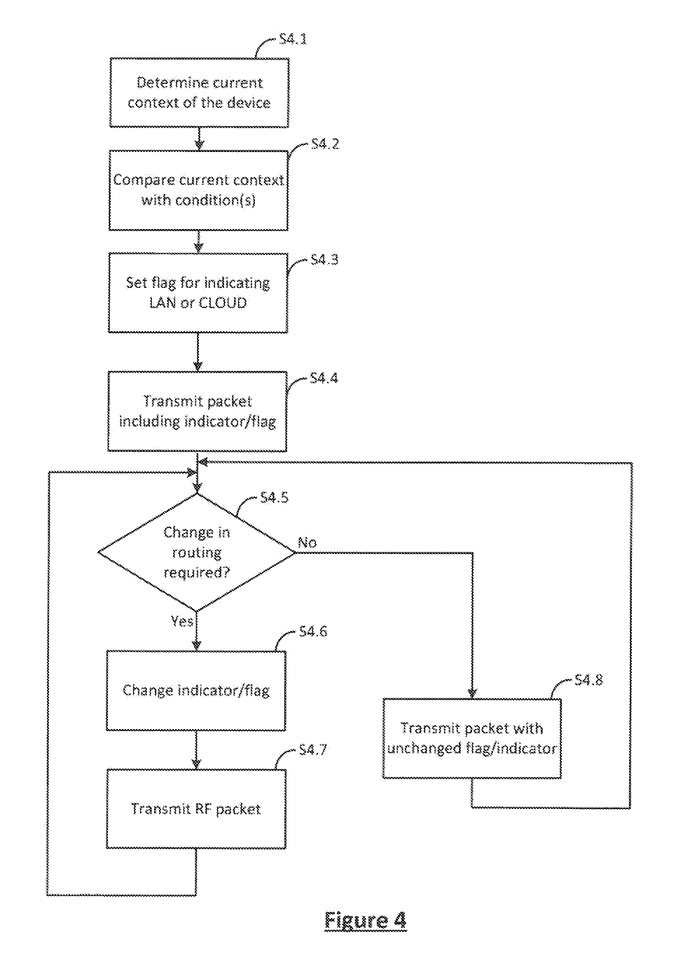

FIG. 4 is a flow chart illustrating a method which may be performed by the trackable devices 13 according to some examples. More specifically, the method may be performed by trackable devices which are configured to dictate the routing destination to the routing determination apparatus 12.

In operation S4.1, the trackable device 13 determines based on locally-available data, its current context. The locally-available data may include, among other things, data derived from one or more sensors 131, battery level data and the time.

Next, in operation S4.2, the trackable device compares the current context with one or more conditions and, based on the comparison determines if LAN server apparatus 11 or the cloud server apparatus 14 should determine its position (put another way, whether the position determination should be high latency or low latency).

Next, in operation S4.3, the trackable device 13 sets a flag or indicator in a data packet for transmission, which indicates the determined routing destination for the data packet. The flag or indicator may include one or more bits, the state of which indicates the routing destination.

Subsequently, in operation S4.4, the trackable device 13 causes transmission of the data packet including the flag. As discussed previously, the data packet additionally includes a trackable device ID for identifying the trackable device 13. In some examples, such as when HAIP is used, the data packet may additionally include a specific data portion for enabling the locator device 10A to enable the angle of arrival of the data packet. Transmission of the data packet may be, for instance, by Bluetooth low energy. However, in other examples a different protocol may be used.

Next, in operation S4.5, the trackable device 13 determines if a change in routing destination is required. This may be based on, for instance, a change in the relationship between the current context and the one or more conditions. If it is determined that a change in the routing destination is required, the trackable device proceeds to operation S4.6 in which the flag in a subsequent data packet is changed. After this, the subsequent data packet including the modified flag is caused to be transmitted in operation S4.7. Next, the trackable device 13 returns to operation S4.5.

If, however, the trackable device 13 determines in operation S4.5 that a change in routing destination is not required, the device 13 proceeds to operation S4.8 in which a data packet having a flag indicating an unchanged routing destination transmitted. After this, operation S4.8 is once again carried out.

### Example Implementations

The above described system may be applicable in many different scenarios in which the tracking of trackable devices is desired. For instance, let us consider a scenario in which the positioning system is being used within a sporting arena (such as an ice hockey arena). In such a scenario, trackable devices may be associated with each of the players. The system may, for example, be configured to switch from high latency location tracking (i.e. position determination performed by the cloud server apparatus) to low latency location tracking (i.e. position determination performed by the LAN server apparatus) when a particular player is determined to have entered the area of play (e.g. the rink, court etc.) from the reserve bench. In such an example, a geo-fence around the area of play may be applied. As such, when the cloud server apparatus 14 determines that the trackable device 13 associated with the player is no longer outside the geofence, it causes a routing control message to be sent to the routing determination apparatus 12 for causing the current routing destination to be updated in the database 1202B to indicate the LAN positioning server apparatus 11 as the current routing destination. Data derived from receipt of subsequently received packets is then routed to the LAN positioning server apparatus 11.

In some examples, the ball or puck may include a trackable device. The position of the trackable device associated with the ball/puck may normally be processed with high latency (i.e. by the cloud server apparatus 14). However, when it is determined that the ball/puck has crossed a geo-fence which specifies a certain radius around the goal or the like, the system 1 may cause a switch to low latency position determination (i.e. by the LAN server apparatus) to be made. Low latency processing when the ball/puck is near the goal may be useful for determining in near real-time whether the ball/or puck has crossed the goal line. A similar switch (from high to low latency processing) may be made when trackable devices carried by players approach within a predetermined range of the trackable device provided in the ice ball/puck. Likewise, the switch to low latency may be made when certain players approach within a predetermined range of another player.

In other examples, the switch between routing destination may be made based on the velocity or acceleration of the players or the ball/puck. As such, when the sensor data or successively determined positions indicate that the ball/puck or players are moving with below a threshold velocity or acceleration, high latency position determination (i.e. by the cloud server apparatus) may be used. However, when the velocity or acceleration exceeds a threshold the routing destination is switched to the LAN server apparatus 11 and so a low latency position determination is performed by the LAN server apparatus 11.

In the same scenario, the routing determination apparatus 12 may determine that all packets received from trackable devices 13 associated with spectators should be routed to the cloud server apparatus 14 because high latency position determination is sufficient.

In another scenario, the system 1 described herein may be used for tracking assets or people in a facility such as a shopping mall, factory, hospital, prison, warehouse etc. In a factory for instance, the routing determination may be based on, for example, data from a sensor (e.g. an accelerometer) in the trackable device 13 such that when a certain movement characteristic associated with a particular device is low, high latency positioning (by the cloud server apparatus 14) may be employed. However, when the device starts to move (i.e. the movement characteristic is above a threshold) tracking for the device may be switched to low latency positioning by the LAN positioning server apparatus 11. Similarly, in a prison or hospital, when person carrying a trackable device is in a public unsecure area, high latency positioning may be sufficient. However, when the person enters or approaches a secure area, low latency positioning by the LAN server apparatus 11 may be employed.

In other scenarios, the routing determination may be made on the basis of a priority level associated with the trackable device 13 or its user. The priority level may be indicated in the data packets transmitted by the trackable devices 13, may be stored in the routing database 1202B. In a sporting context, for instance, professional and amateur sports people may be training within the same facility. In such an example, the devices 13 associated with the professional sports people may have an associated high priority while those associated with the amateurs may have a low priority. In a non-sporting context, devices 13 used for tracking high value assets (e.g. expensive equipment in a hospital or factory) may be high priority and low value assets may be low priority. In both contexts, it may be possible to manually configure the priority level associated with a particular device, either by providing a manual input to the trackable device 13 or by manually causing the routing determination database to be updated.

In other examples, the priority level of the devices (in either context) may be dynamically determined by the routing determination apparatus 12 or the trackable device 13 based on other factors such as but not limited to information derived from sensor data (e.g. movement) and/or position. As such, those devices which satisfy particular conditions (for instance which are within a certain area and/or are moving at a certain velocity) may be treated as high priority and those which do not satisfy the conditions may be treated with low priority. In some examples, the priority may be a value calculated by the routing determination apparatus 12 based on various “other factors” (for example, it may be a weighted sum of first and second factors, e.g. velocity and a distance from a geo-fence).

The routing determination apparatus 12 may be configured to route data associated with high priority devices in the low latency manner (i.e. to the LAN server apparatus 11) and to route the data associated with low priority devices in the high latency manner (i.e. to the cloud server apparatus 14). However, the routing determination may in some examples also depend on a capacity/computational resources of the LAN server apparatus 11. For instance, the LAN server may have computational resources to be able to provide position determination for a threshold number of devices, e.g. 100. In such examples, if there are less than the threshold number of high priority devices, all high priority devices may have their positions determined using the LAN server apparatus 11. In some instances, certain low priority devices may also have their positions determined by the LAN server apparatus 11 until the capacity of the LAN server is reached. Those low priority devices (whose data is processed using the LAN server) may be selected in a number of different ways (e.g. highest speed, nearest to a geo-fence or first-come-first-served). On the other hand, if the number of high priority devices exceeds the threshold, the routing determination apparatus 12 may be configured to select those high priority devices for which the position will be determined by the LAN server apparatus 11, with the positions of the other high priority devices being determined by the cloud server apparatus 14. Again, the selection may be made in any number of different ways. In examples in which the priority is a calculated value, data from X number of devices (e.g. the threshold number) having the highest priority value may be processed by the LAN server apparatus whereas data from all other devices may be processed by the cloud server apparatus. Alternatively, the positions of devices with a priority value above a threshold value may be processed by the LAN server (as far as the capacity of the LAN server allows), with positions of devices with a priority value below the threshold being processed by the cloud server.

Some further details of components and features of the above-described apparatuses and devices 10A, 10B, 11, 12, 13, 14, 15 illustrated in FIG. 1 and alternatives for them will now be described.

In the example of FIG. 1 the HAIP locator device 10A is configured to enable a bearing from the trackable device 13 to the locator device 10A to be determined based on data derived from receipt of a data packet which includes a specific data portion. The HAIP locator device 10A includes a phased array of antennas 101. The antennas of the array 101 are connected to transceiver circuitry 102 via a switch mechanism 103 which is configured to connect only one of the antennas to the transceiver circuitry 101 at any one time. The bearing to the trackable device 13 is determinable based on data derived from the receipt of the specific data portion of the data packet as the switch mechanism 103 sequentially connects a different one of the antennas to the transceiver circuitry 102. The data derived from the receipt of the data packet may, in some specific examples, include I and Q data. The locator device 10A further includes a controller 104 for controlling the other components of the device 10A for providing various functionalities as in the manner discussed above and. For instance, the controller 104 may cause data, derived from receipt of data packets from the trackable device 13, to be provided to the routing determination apparatus 12.

HAIP as developed by Nokia is known in the art. Indeed, it is mentioned, and is described in various levels of detail, in (among other publications) the following published PCT patent applications: WO 2014087196A1, WO2013179195A1, WO2014087198A1, WO 2015013904A1, WO 2014107869A1, WO2014108753A1, WO2014087199A1 and WO 2014087197A1. In view of these and other disclosures, the fundamental principles utilised by the trackable device 13, locator devices 10A, 10B and the positioning server apparatuses 11, 14 to provide HAIP are not described in further detail in this specification.

The HAIP locator device 10A may be capable of operating in both of the high-accuracy positioning mode and the cost-optimised positioning mode. When operating in the cost-optimised mode, the device 10A may be configured so as to use just one of the antennas of the array 110 to receive data packets from the trackable device 13.

The dedicated COIP locator device 10B is configured to operate in cost-optimised indoor positioning and may include a single antenna 105, which is connected to transceiver circuitry 106, for receiving data packets from the trackable devices 13. The functionality provided by cost-optimised locator device 10B may be controlled (or caused) by a controller 107 which forms part of the locator device 10B. The COIP locator device 10B may be configured to enable a determination that a trackable device 13 is within communications range of the locator device 10B based on receipt of a data packets from the trackable device 13. In some instances, the locator device 10B may further enable a determination as to the position of the trackable device 13 with a higher accuracy (e.g. approximately 3 m). This may, however, require multiple locator devices 10B operating in the cost-optimised mode to receive the same data packet from a particular trackable device 13, with the position being determined using a measured signal strength of the data packet at each locator device 10B and a radio-map of the area in which the locator devices 10B are provided.

Each of the locator devices 10A, 10B includes an output interface 109, 108 via which the data derived from received data packets are provided to the routing determination apparatus. These interfaces 108, 109 may be of any suitable type depending on the type of connection between the locator devices 10A, 10B and the routing determination apparatus 12.

The controllers 104, 107, 110, 120, 130, 140, 150 of each of the apparatuses or devices 10A, 10B, 11, 12, 13, 14, 15 comprise processing circuitry 1041, 1071, 1101, 1201, 1301, 1401, 1501 communicatively coupled with memory 1042, 1072, 1102, 1202, 1302, 1402, 1502. The memory 1042, 1072, 1102, 1202, 1302, 1402, 1502 has computer-readable instructions 1042A, 1072A, 1102A, 1202A, 1302A, 1402A, 1502A stored thereon, which when executed by the processing circuitry 1041, 1071, 1101, 1201, 1301, 1401, 1501 causes the processing circuitry 1041, 1071, 1101, 1201, 1301, 1401, 1501 to cause performance of various ones of the operations described with reference to FIGS. 1 to 4. The controllers 104, 107, 110, 120, 130, 140, 150 may in some instance be referred to, in general terms, as “apparatus”.

The processing circuitry 1041, 1071, 1101, 1201, 1301, 1401, 1501 of any of the apparatuses 10A, 10B, 11, 12, 13, 14, 15 described with reference to FIGS. 1 to 4 may be of any suitable composition and may include one or more processors 1041A, 1071A, 1101A, 1201A, 1301A, 1401A, 1501A of any suitable type or suitable combination of types. For example, the processing circuitry 1041, 1071, 1101, 1201, 1301, 1401, 1501 may be a programmable processor that interprets computer program instructions 1042A, 1072A, 1102A, 1202A, 1302A, 1402A, 1502A and processes data. The processing circuitry 1041, 1071, 1101, 1201, 1301, 1401, 1501 may include plural programmable processors. Alternatively, the processing circuitry 1041, 1071, 1101, 1201, 1301, 1401, 1501 may be, for example, programmable hardware with embedded firmware. The processing circuitry 1041, 1071, 1101, 1201, 1301, 1401, 1501 may be termed processing means. The processing circuitry 1041, 1071, 1101, 1201, 1301, 1401, 1501 may alternatively or additionally include one or more Application Specific Integrated Circuits (ASICs). In some instances, processing circuitry 1041, 1071, 1101, 1201, 1301, 1401, 1501 may be referred to as computing apparatus.

The processing circuitry 1041, 1071, 1101, 1201, 1301, 1401, 1501 is coupled to the respective memory (or one or more storage devices) 1042, 1072, 1102, 1202, 1302, 1402, 1502 and is operable to read/write data to/from the memory 1042, 1072, 1102, 1202, 1302, 1402, 1502. The memory 1042, 1072, 1102, 1202, 1302, 1402, 1502 may comprise a single memory unit or a plurality of memory units, upon which the computer readable instructions (or code) 1042A, 1072A, 1102A, 1202A, 1302A, 1402A, 1502A is stored. For example, the memory 1042, 1072, 1102, 1202, 1302, 1402, 1502 may comprise both volatile memory and non-volatile memory. For example, the computer readable instructions 1042A, 1072A, 1102A, 1202A, 1302A, 1402A, 1502A may be stored in the non-volatile memory and may be executed by the processing circuitry 1041, 1071, 1101, 1201, 1301, 1401, 1501 using the volatile memory for temporary storage of data or data and instructions. Examples of volatile memory include RAM, DRAM, and SDRAM etc. Examples of non-volatile memory include ROM, PROM, EEPROM, flash memory, optical storage, magnetic storage, etc. The memories in general may be referred to as non-transitory computer readable memory media.

The term ‘memory’, in addition to covering memory comprising both non-volatile memory and volatile memory, may also cover one or more volatile memories only, one or more non-volatile memories only, or one or more volatile memories and one or more non-volatile memories.

The computer readable instructions 1042A, 1072A, 1102A, 1202A, 1302A, 1402A, 1502A may be pre-programmed into the apparatuses 10A, 10B, 11, 12, 13, 14, 15. Alternatively, the computer readable instructions 1042A, 1072A, 1102A, 1202A, 1302A, 1402A, 1502A may arrive at the apparatus 10A, 10B, 11, 12, 13, 14, 15 via an electromagnetic carrier signal or may be copied from a physical entity 17 (see FIG. 1) such as a computer program product, a memory device or a record medium such as a CD-ROM or DVD. The computer readable instructions 1042A, 1072A, 1102A, 1202A, 1302A, 1402A, 1502A may provide the logic and routines that enables the devices/apparatuses 10A, 10B, 11, 12, 13, 14, 15 to perform the functionality described above. The combination of computer-readable instructions stored on memory (of any of the types described above) may be referred to as a computer program product.

Where applicable, the BLE-capability of the apparatuses 10A, 10B, 11, 12, 13, 14, 15 may be provided by a single integrated circuit. It may alternatively be provided by a set of integrated circuits (i.e. a chipset). The BLE-capability may alternatively be a hardwired, application-specific integrated circuit (ASIC).

As will be appreciated, the apparatuses 10A, 10B, 11, 12, 13, 14, 15 described herein may include various hardware components which have may not been shown in the Figures. For instance, the trackable device 13 may in some implementations be a portable computing device such as a mobile telephone or a tablet computer and so may contain components commonly included in a device of the specific type. Similarly, the apparatuses 10A, 10B, 11, 12, 13, 14, 15 may comprise further optional software components which are not described in this specification since they may not have direct interaction to embodiments of the invention.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

As used in this application, the term ‘circuitry’ refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. A method comprising:
based on at least one of data included in a radio frequency data packet received from a trackable device and stored routing information associated with the trackable device, determining which of local area network server apparatus and cloud server apparatus is to determine a position of the trackable device based on data derived from receipt of the radio frequency data packet; and
in response to determining that the cloud server apparatus is to determine the location of the trackable device, causing the data derived from the receipt of the radio frequency data packet to be routed towards the cloud server apparatus.

2. The method of claim 1, comprising, in response to determining that the local area network server apparatus is to determine the location of the trackable device, either:
causing the data derived from the receipt of the radio frequency data packet to be routed towards the local area network server apparatus; or
causing the position of the trackable device to be determined based on the data derived from the receipt of the radio frequency data packet.

3. The method of either preceding claim, wherein the data included in the radio frequency data packet received from the trackable device is derived from an output of a movement sensor located at the trackable device and being indicative of a degree of movement of the trackable device.

4. The method of claim 3, comprising:
determining which of the local area network server apparatus and the cloud server apparatus is to determine the position of the transmission based on a determination as to whether the degree of movement of the trackable device satisfies a predefined condition.

5. The method of claim 4, comprising:
determining that the local area network server apparatus is to determine the position of the trackable device if the data derived from the output of the movement sensor indicates that the degree of movement is above a threshold value; and
determining that the cloud server apparatus is to determine the position of the trackable device if the data derived from the movement sensor indicates a degree of movement which is below a threshold value.

6. The method of claim 4 or claim 5, wherein the predefined condition is indicated by the stored routing information.

7. The method of any of claims 1 to 3, wherein the data included in the radio frequency data packet received from the trackable device includes an indicator comprising one or more bits, the state of which indicate which of the local area network server apparatus and the cloud server apparatus is to determine the position of the trackable device.

8. The method of claim 1 or claim 2, wherein the stored routing information indicates a current routing destination for the data derived from the receipt of the radio frequency data packet.

9. The method of claim 8 comprising:
receiving control information from the cloud server apparatus or the local area network server apparatus and responding by updating the current routing destination.

10. The method of claim 8 or claim 9, wherein the current routing destination was set based on a previously-determined position of the trackable device relative to a geo-fence.

11. The method of claim 10, wherein the geo-fence is dynamically defined based on a position of a second trackable device.

12. A method comprising:
determining a current context of a trackable device based on data associated with a radio frequency data packet transmitted by the trackable device; and
based on the determined current context of the trackable device, causing transmission of a routing control message for indicating to a recipient which of a local area network server apparatus and a cloud server apparatus is to be used to determine a position of the trackable device based on subsequent radio frequency data packets transmitted by the trackable device.

13. The method of claim 12, comprising:
receiving the data associated with the radio frequency data packet transmitted by the trackable device; and
based on the received data, determining a position of the trackable device;
determining the current context based on at least the determined position of the trackable device.

14. The method of claim 12 or claim 13 wherein the current context comprises at least one of a current position of the trackable device, a current movement characteristic and a current heading of the trackable device.

15. The method of claim 12, 13 or 14, wherein the data associated with the radio frequency data packet transmitted by the trackable device includes at least one of data derived from receipt of the radio frequency data packet at a locator device and sensor data derived from at least one sensor forming part of the trackable device.

16. A method comprising:
determining a current context of a trackable device based on data that is locally available to the trackable device;
based on the determined current context of the trackable device, providing in a radio frequency data packet, for transmission by the trackable device to a locator device, an indicator for indicating which one of a local area network server apparatus and a cloud server apparatus is to be used to determine a position of the trackable device based on data derived from receipt of the radio frequency data packet at the locator device.

17. The method of claim 16, wherein the data that is locally available to the trackable device includes data derived from at least one sensor forming part of the trackable device.

18. The method of claim 17, wherein the at least one sensor comprises a sensor for detecting movement of the trackable device and the current context relates to a characteristic of the movement of the device.

19. Apparatus configured to perform a method according to any preceding claim.

20. Computer-readable instructions which when executed by computing apparatus cause the computing apparatus to perform a method as claimed in any of claims 1 to 18.

21. Apparatus comprising:
at least one processor; and
at least one memory including computer program code, which when executed by the at least one processor, causes the apparatus:
based on at least one of data included in a radio frequency data packet received from a trackable device and stored routing information associated with the trackable device, to determine which of local area network server apparatus and cloud server apparatus is to determine a position of the trackable device based on data derived from receipt of the radio frequency data packet; and
in response to determining that the cloud server apparatus is to determine the location of the trackable device, to cause the data derived from the receipt of the radio frequency data packet to be routed towards the cloud server apparatus.

22. The apparatus of claim 21, wherein the computer program code, when executed by the at least one processor, causes the apparatus, in response to determining that the local area network server apparatus is to determine the location of the trackable device, either:
to cause the data derived from the receipt of the radio frequency data packet to be routed towards the local area network server apparatus; or
to cause the position of the trackable device to be determined based on the data derived from the receipt of the radio frequency data packet.

23. The apparatus of either of claims 21 and 22, wherein the data included in the radio frequency data packet received from the trackable device is derived from an output of a movement sensor located at the trackable device and being indicative of a degree of movement of the trackable device.

24. The apparatus of claim 23, wherein the computer program code, when executed by the at least one processor, causes the apparatus to determine which of the local area network server apparatus and the cloud server apparatus is to determine the position of the transmission based on a determination as to whether the degree of movement of the trackable device satisfies a predefined condition.

25. The apparatus of claim 24, wherein the computer program code, when executed by the at least one processor, causes the apparatus:
to determine that the local area network server apparatus is to determine the position of the trackable device if the data derived from the output of the movement sensor indicates that the degree of movement is above a threshold value; and
to determine that the cloud server apparatus is to determine the position of the trackable device if the data derived from the movement sensor indicates a degree of movement which is below a threshold value.

26. The apparatus of claim 24 or claim 25, wherein the predefined condition is indicated by the stored routing information.

27. The apparatus of any of claims 21 to 23, wherein the data included in the radio frequency data packet received from the trackable device includes an indicator comprising one or more bits, the state of which indicate which of the local area network server apparatus and the cloud server apparatus is to determine the position of the trackable device.

28. The apparatus of claim 21 or claim 22, wherein the stored routing information indicates a current routing destination for the data derived from the receipt of the radio frequency data packet.

29. The apparatus of claim 28, wherein the computer program code, when executed by the at least one processor, causes the apparatus:
to receive control information from the cloud server apparatus or the local area network server apparatus and to respond by updating the current routing destination.

30. The apparatus of claim 28 or claim 29, wherein the current routing destination was set based on a previously-determined position of the trackable device relative to a geo-fence.

31. The apparatus of claim 30, wherein the geo-fence is dynamically defined based on a position of a second trackable device.

32. Apparatus comprising:
at least one processor; and
at least one memory including computer program code, which when executed by the at least one processor, causes the apparatus:
to determine a current context of a trackable device based on data associated with a radio frequency data packet transmitted by the trackable device; and
based on the determined current context of the trackable device, to cause transmission of a routing control message for indicating to a recipient which of a local area network server apparatus and a cloud server apparatus is to be used to determine a position of the trackable device based on subsequent radio frequency data packets transmitted by the trackable device.

33. The apparatus of claim 32, wherein the computer program code, when executed by the at least one processor, causes the apparatus:
to receive the data associated with the radio frequency data packet transmitted by the trackable device;
based on the received data, to determine a position of the trackable device; and
to determine the current context based on at least the determined position of the trackable device.

34. The apparatus of claim 32 or claim 33 wherein the current context comprises at least one of a current position of the trackable device, a current movement characteristic and a current heading of the trackable device.

35. The apparatus of claim 32, 33 or 34, wherein the data associated with the radio frequency data packet transmitted by the trackable device includes at least one of data derived from receipt of the radio frequency data packet at a locator device and sensor data derived from at least one sensor forming part of the trackable device.

36. Apparatus comprising:
at least one processor; and
at least one memory including computer program code, which when executed by the at least one processor, causes the apparatus:
to determine a current context of a trackable device based on data that is locally available to the trackable device;
based on the determined current context of the trackable device, to provide in a radio frequency data packet, for transmission by the trackable device to a locator device, an indicator for indicating which one of a local area network server apparatus and a cloud server apparatus is to be used to determine a position of the trackable device based on data derived from receipt of the radio frequency data packet at the locator device.

37. The apparatus of claim 36, wherein the data that is locally available to the trackable device includes data derived from at least one sensor forming part of the trackable device.

38. The apparatus of claim 37, wherein the at least one sensor comprises a sensor for detecting movement of the trackable device and the current context relates to a characteristic of the movement of the device.

39. A computer-readable medium having computer-readable code stored thereon, the computer readable code, when executed by a least one processor, cause performance of at least:
determining, based on at least one of data included in a radio frequency data packet received from a trackable device and stored routing information associated with the trackable device, which of local area network server apparatus and cloud server apparatus is to determine a position of the trackable device based on data derived from receipt of the radio frequency data packet; and
in response to determining that the cloud server apparatus is to determine the location of the trackable device, causing the data derived from the receipt of the radio frequency data packet to be routed towards the cloud server apparatus.

40. A computer-readable medium having computer-readable code stored thereon, the computer readable code, when executed by a least one processor, cause performance of at least:
determining a current context of a trackable device based on data associated with a radio frequency data packet transmitted by the trackable device; and
based on the determined current context of the trackable device, causing transmission of a routing control message for indicating to a recipient which of a local area network server apparatus and a cloud server apparatus is to be used to determine a position of the trackable device based on subsequent radio frequency data packets transmitted by the trackable device.

41. A computer-readable medium having computer-readable code stored thereon, the computer readable code, when executed by a least one processor, cause performance of at least:
determining a current context of a trackable device based on data that is locally available to the trackable device;
based on the determined current context of the trackable device, providing in a radio frequency data packet, for transmission by the trackable device to a locator device, an indicator for indicating which one of a local area network server apparatus and a cloud server apparatus is to be used to determine a position of the trackable device based on data derived from receipt of the radio frequency data packet at the locator device.

42. Apparatus comprising:
means for determining, based on at least one of data included in a radio frequency data packet received from a trackable device and stored routing information associated with the trackable device, which of local area network server apparatus and cloud server apparatus is to determine a position of the trackable device based on data derived from receipt of the radio frequency data packet; and
means for causing, in response to determining that the cloud server apparatus is to determine the location of the trackable device, the data derived from the receipt of the radio frequency data packet to be routed towards the cloud server apparatus.

43. Apparatus comprising:
means for determining a current context of a trackable device based on data associated with a radio frequency data packet transmitted by the trackable device; and
means for causing, based on the determined current context of the trackable device, transmission of a routing control message for indicating to a recipient which of a local area network server apparatus and a cloud server apparatus is to be used to determine a position of the trackable device based on subsequent radio frequency data packets transmitted by the trackable device.

44. Apparatus comprising:
means for determining a current context of a trackable device based on data that is locally available to the trackable device;
means for providing, based on the determined current context of the trackable device, in a radio frequency data packet, for transmission by the trackable device to a locator device, an indicator for indicating which one of a local area network server apparatus and a cloud server apparatus is to be used to determine a position of the trackable device based on data derived from receipt of the radio frequency data packet at the locator device.
